(19) United States
(12) Patent Application Publication
(10) Pub. No.: US 2019/0020207 A1
(43) Pub. Date: Jan. 17, 2019

(54) BEVERAGE CONTAINER SLEEVE WITH MOBILE DEVICE CHARGER

(71) Applicant: Keely Rhodes, Lakeland, FL (US)

(72) Inventor: Keely Rhodes, Lakeland, FL (US)

(21) Appl. No.: 15/651,100

(22) Filed: Jul. 17, 2017

(51) Int. Cl. H02J 7/00; B67B 5/03; B65B 21/24

(52) U.S. Cl. CPC H02J 7/0044; B67B 5/036; B67B 5/00; H02J 7/0034; H02J 7/0045; B65B 21/24

(57) ABSTRACT

A beverage container sleeve comprising a power bank configured for recharging mobile devices. The sleeve has a beverage container compartment and a power bank compartment, which is attached to the bottom of the beverage container compartment. The power bank compartment has a charging port, and the power bank has a mobile device charging plug receptacle. The power bank compartment is adapted for removably receiving the power bank such that the charging port is in aligned communication with the mobile device charging plug receptacle.

### BACKGROUND

### 1. Field of Invention

The present invention relates generally to the field of beverage container sleeves, and more particularly, to a beverage container sleeve comprising a power cell to charge external mobile devices.

### 2. Description of Related Art

With an increasingly mobile population and the prevalence of mobile, rechargeable devices, it has become commonplace for people to find themselves with many devices, gadgets, and objects to carry while on the move. Such people include commuters, concert goers, shoppers, students, and those in many other walks of life. For example, many commuters find themselves on the move with more mobile objects and devices than they have means to carry. In addition to these challenges and frustrations, people on the move may find that a device they need has lost the charge in its battery, or that it was never recharged. One solution to this problem is to carry a portable recharger, sometimes called a portable power cell or power station. However, this simply adds yet another device to the collection of items already in tow by the user.

There have been many prior attempts to reduce the number of such mobile objects, such as by combining beverage containers, tumblers, and cups with various other devices, such as radios, MP3 players, temperature sensors, and other components. However, these prior devices do not meet some of the needs of a modern mobile population.

The present device seeks to overcome at least some of these problems by combining a beverage container sleeve with a portable power bank configured to recharge portable electronic devices.

### SUMMARY OF THE PREFERRED EMBODIMENTS

The present device is a beverage container sleeve that comprises a beverage container compartment, a power bank compartment, and a power bank or mobile device charger. The power bank compartment is attached to the bottom of the beverage container compartment. The power bank compartment has a charging port, which is preferably disposed in a sidewall of the power bank compartment.

The power bank has one or more mobile device charging plug receptacles for removably receiving a plug or adapter attached to the end of a mobile device power cable. When the power bank is inserted into the power bank compartment, the power bank is disposed such that at least one of the plug receptacles is aligned in communication with the charging port in the power bank compartment. The power bank comprises a rechargeable power cell capable of receiving an electric power charge through a cell charging port, storing the power charge, and then discharging the power charge via the plug receptacle to charge a mobile device. It is preferred, but not required, that the power bank is cylindrical in shape, having a diameter that is approximately the same diameter as the type of beverage container intended for insertion into the beverage container compartment.

The sleeve may comprise a divider disposed between the beverage container compartment and the power bank compartment. In one embodiment, the divider is disposed in proximity to the attachment interface between the beverage container compartment and the power bank compartment. In this embodiment, it is preferable, but not required, that the divider is a circular or substantially circular panel having a circumferential edge with a fixed portion and a free portion, the fixed portion being attached to the inside of either the beverage container compartment or the power bank compartment such that the free portion of the circumferential edge enables the divider to be drawn into an open position to enable the removable insertion of the power bank into the power bank compartment. The fixed portion could be a portion of the circumferential edge that is sewn or otherwise attached to the inside of the sleeve.

As an alternative, the sleeve could comprise a hard, durable material that forms an exterior shell. In this embodiment, the power bank compartment is attached to the beverage container compartment by a connection mechanism, which could comprise a threaded connection, a clip assembly, or another suitable mechanical attachment mechanism.

### BRIEF DESCRIPTION OF THE DRAWINGS

FIG. 1 is a cut-away perspective view showing one embodiment of the sleeve with a power bank installed in the power bank compartment.

FIG. 2 is a cross sectional view of one embodiment of a sleeve where the power bank compartment has an aperture for removably receiving a power bank.

FIG. 3 is an isometric view of one embodiment of a power bank.

FIG. 4 shows an embodiment of the sleeve configured to receive a beverage bottle.

FIG. 5 is a cross sectional view of one embodiment of a sleeve where a divider has a fixed portion and a free portion, and the sleeve 1 comprises a shelf configured to support the free portion of the divider.

FIG. 6 is a cross sectional view of one embodiment of a sleeve having a free-floating divider, with arrows showing the direction of movement of the divider.

FIG. 7 is a partial cross sectional view showing one embodiment of a connection mechanism between the power bank compartment and the beverage container compartment, the connection mechanism being a threaded connection.

FIG. 8 is a partial cross sectional view showing one embodiment of a connection mechanism between the power bank compartment and the beverage container compartment, the connection mechanism being a clip assembly.

### DETAILED DESCRIPTION OF THE PREFERRED EMBODIMENTS

With reference to the drawings, the beverage container sleeve will now be described with regard for the best mode and the preferred embodiments. In general, the device disclosed herein is a beverage container sleeve having a power bank for recharging mobile devices. The embodiments disclosed herein are meant for illustration and not limitation of the inventive scope. An ordinary practitioner will appreciate that it is possible to create many variations or combinations of the following embodiments without undue experimentation.

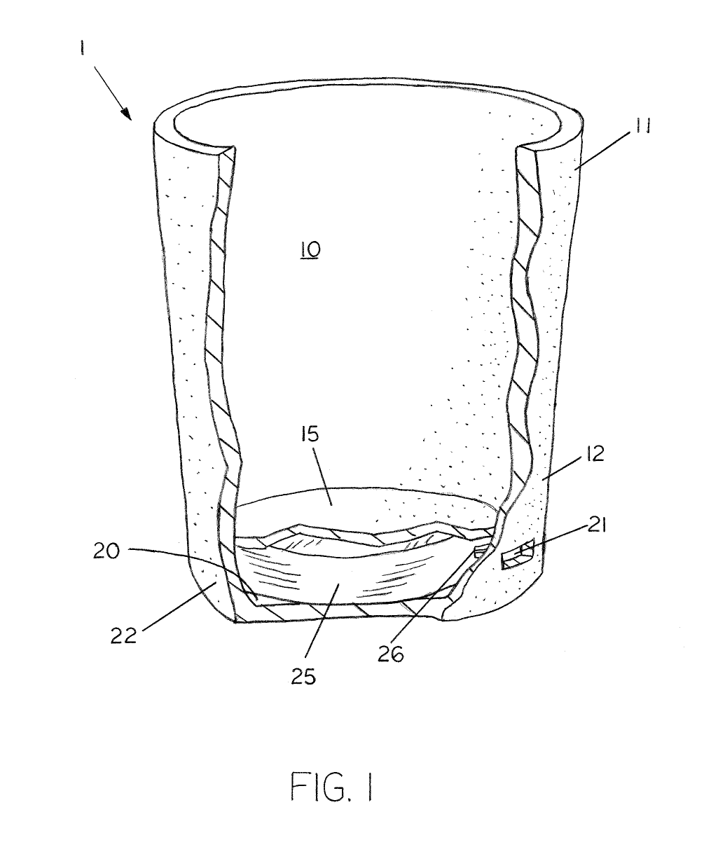

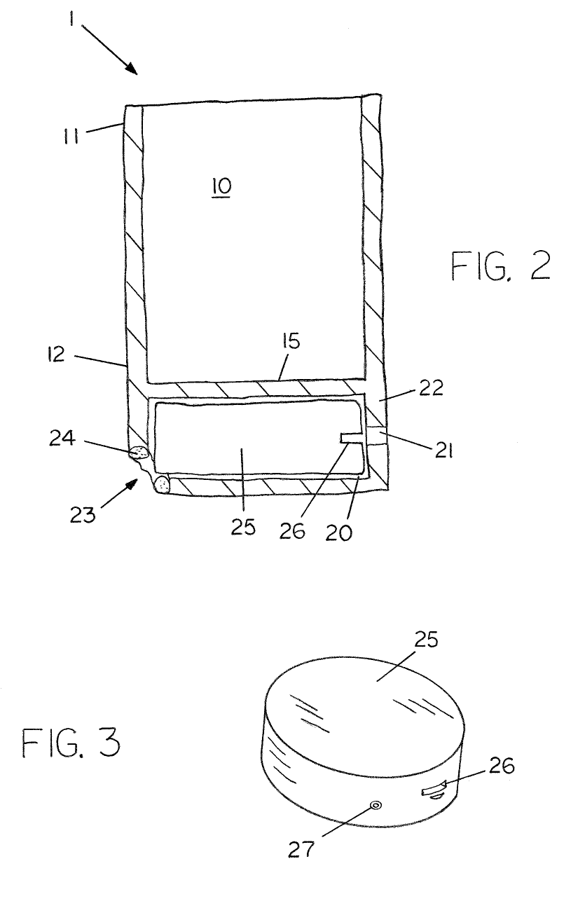

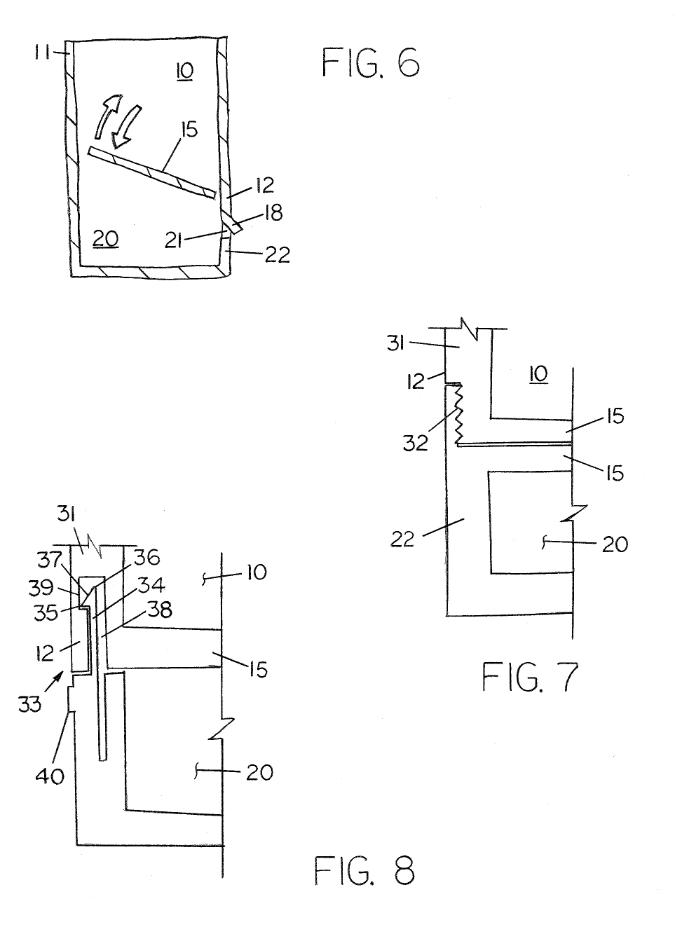

Referring to FIGS. 1-2, in one embodiment, the beverage container sleeve 1 comprises a beverage container compartment 10, a power bank compartment 20, and a power bank 25. The beverage container compartment 10 has a top 11 and a bottom 12, and the power bank compartment 20 is attached to the bottom 12 of the beverage container compartment 10. The power bank compartment 20 has a charging port 21, which is preferably disposed in a sidewall 22 of the power bank compartment 20. The charging port 21 or the sidewall 22 may further comprise a cover member 18 (see FIG. 6) to cover the charging port 21 when it is not in use. The cover member 18 could be a flap, a slit, a slot, or some other component of the sidewall 22 or of the port 21. For example, in one embodiment the cover member 18 is a portion of the sidewall 22 that forms a flap to cover the charging port 21 when the port 21 is not in use.

One embodiment of the power bank compartment 20, shown in FIG. 2, further comprises an aperture 23, and the power bank 25 is adapted to be removably inserted into the power bank compartment 20 through the aperture 23. It is preferred, but not required, that the aperture 23 comprises an elastic collar 24 configured to expand the aperture 23 for inserting the power bank 25 into the power bank compartment 20. The elastic collar 24 then contracts such that the power bank 25 is snugly retained inside the power bank compartment 20. Similarly, the elastic collar 24 expands the aperture 23 for removal of the power bank 25 from the power bank compartment 20. Once the power bank 25 is so removed, the elastic collar 24 then contracts to prevent unwanted objects or debris from entering the power bank compartment 20.

Referring to FIG. 3, the power bank 25 has one or more mobile device charging plug receptacles 26 for removably receiving a plug or adapter attached to the end of a mobile device power cable. For example, the plug receptacle 26 could be a female USB connector for removably receiving a male USB connector. An ordinary practitioner will appreciate that the plug receptacle 26 could be a one of a number of other similar jacks, receptacles, or connectors for charging mobile devices. When the power bank 25 is inserted into the power bank compartment 20, the power bank 25 is disposed such that at least one of the plug receptacles 26 is aligned in communication with the charging port 21 in the power bank compartment 20. This alignment enables a mobile device charging cable to connect to the plug receptacle 26 without interference from the sidewall 22 or other components of the power bank compartment 20.

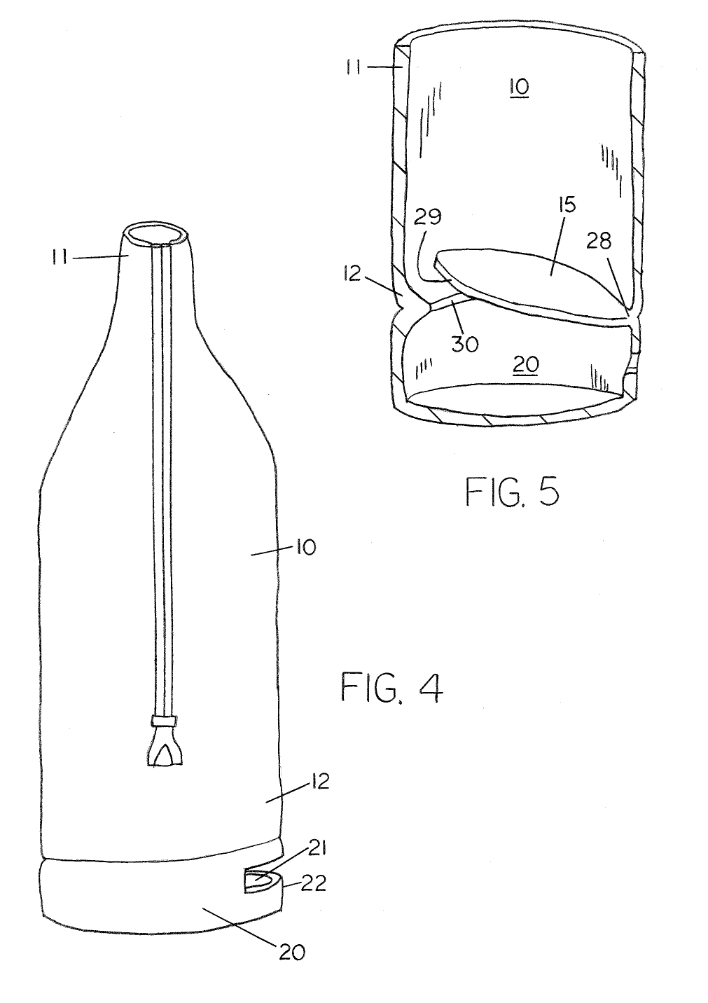

The power bank 25 comprises a rechargeable power cell (not shown) capable of receiving an electric power charge through a cell charging port 27, storing the power charge, and then discharging the power charge via the plug receptacle 26 to charge a mobile device. A typical mobile device could be a cellular telephone, a tablet computer, a portable Bluetooth speaker, or a similar portable or hand-held electronic device having a rechargeable battery. It is preferred, but not required, that the power bank 25 is cylindrical in shape, having a diameter that approximately the same diameter as the type of beverage container intended for insertion into the beverage container compartment 10. For example, as shown in FIG. 4, the power bank 25 should have a diameter that does not cause the sidewalls 22 of the power bank compartment 20 to protrude significantly beyond the diameter of the beverage container compartment 10. Referring again to FIG. 3, the power bank 25 cylinder preferably has a height less than its diameter such that the power bank 25 cylinder is puck-like in shape. In one embodiment, the height of the power bank 25 cylinder is less than ⅝ of its diameter.

In one embodiment of the sleeve 1, the sleeve 1 comprises a divider 15 disposed between the beverage container compartment 10 and the power bank compartment 20. Certain embodiments of the divider 15 are shown in FIGS. 5-6. For example, the divider 15 could be a panel in the bottom 12 of the beverage container compartment 10. As another alternative, the divider 15 could be a top panel for the power bank compartment 20. The divider 15 also could be a free-floating panel member that rests on the top of the power bank 25 (See FIG. 6).

As yet another alternative, referring again to FIG. 5, the divider 15 could be an independent member or panel disposed in proximity to the attachment interface between the beverage container compartment 10 and the power bank compartment 20. In this embodiment, it is preferable, but not required, that the divider is a circular or substantially circular panel having a circumferential edge 19 with a fixed portion 28 and a free portion 29, the fixed portion 28 being attached to the inside of either the beverage container compartment 10 or the power bank compartment 20 such that the free portion 29 of the circumferential edge 19 enables the divider 15 to be drawn into an open position to enable the removable insertion of the power bank 25 into the power bank compartment 20. Once the power bank 25 is inserted into the power bank compartment 20, the divider 15 is then placed back into its flat position before a beverage container is inserted into the beverage container compartment 10. The fixed portion 28 could be a portion of the circumferential edge 19 that is sewn or otherwise attached to the inside of the sleeve 1, it could be a portion of the circumferential edge 19 that is integral with the material from which the sleeve is made, or it could be of some other suitable attachment means or mechanism.

In any of the foregoing embodiments of the divider 15, the sleeve 1 could further comprise a shelf 30 disposed around the inside of the sleeve 1 in an annular orientation, the shelf 30 configured to support the divider 15, and specifically the free portion 29 of the divider's 15 circumferential edge 19.

In any of the foregoing embodiments of the sleeve 1, it is preferred, but not required, that the sleeve 1 and its components, excluding the power bank 25, are substantially constructed from materials comprising foam, neoprene, foam rubber, or another suitable material. Such materials should be flexible, with ample elastic properties.

As an alternative, the sleeve 1 could comprise a hard, durable material that forms an exterior shell 31 (See FIGS. 7 & 8). Suitable materials include plastic, stainless steel, carbon fiber materials, or the like. In this embodiment, the power bank compartment 20 is attached to the beverage container compartment 10 by a connection mechanism 32. As shown in FIG. 7, one embodiment of the connection mechanism 32 is a threaded connection, thus enabling the power bank compartment 20 to be screwed onto the bottom 12 of the beverage container compartment 10.

In another embodiment, shown in FIG. 8, the connection mechanism 32 comprises one or more clip assemblies 33. An example of such a clip assembly 33 is an assembly where the sidewall 22 comprises a flexible arm 34 having a locking barb 35 disposed at a distal end 36 of the arm 34. The locking barb 35 comprises a beveled tip 37. The shell 31 comprises a receiving slot 38 having a recess 39 for receiving the locking barb 35. To connect the power bank compartment 20 to the beverage container compartment 10, the beveled tip 37 is inserted into the receiving slot 38. The barb 35 causes the arm 34 to flex or bend toward the interior of the sleeve 1 until the barb 35 reaches the recess 39. The flex in the arm 34 is then released, and the barb 35 moves laterally in the direction away from the interior of the shell 1, thus causing the barb 35 to enter into and be retained in the recess 39. The barb 35 engages the edge of the recess 39, thus locking the power bank compartment 20 onto the bottom 12 of the beverage container compartment 10.

To release the power bank compartment 20 from the beverage container compartment 10 in this embodiment, a button 40 on the arm 34 is depressed, thereby causing the arm 34 to bend toward the interior of the shell 1 and disengaging the barb 35 from the recess 39. The power bank compartment 20 is then pulled away from the beverage container compartment 10, thereby removing the arm 34 and the barb 35 from the receiving slot 38. In this embodiment, it is advantageous, but not required, that clip assemblies 33 are disposed on opposite sides of the sleeve 1 such that the release buttons 40 can be depressed with equal and opposite forces, thereby maintaining stability of the sleeve 1 as the power bank compartment 20 is detached.

An ordinary practitioner will appreciate that in an embodiment of the sleeve 1 having a hard shell 31, connection mechanism 32 could comprise a variety of clips, clasps, clamps, release tabs, or other mechanisms, all of which are contemplated within the scope of the connection mechanism 32 described herein.

The foregoing embodiments are merely representative of the beverage container sleeve and not meant for limitation of the invention. For example, persons skilled in the art would readily appreciate that there are several embodiments and configurations of the divider, the power bank compartment, and other components will not substantially alter the nature of the beverage sleeve container. Likewise, elements and features of the disclosed embodiments could be substituted or interchanged with elements and features of other embodiments, as will be appreciated by an ordinary practitioner. Consequently, it is understood that equivalents and substitutions for certain elements and components set forth above are part of the invention described herein, and the true scope of the invention is set forth in the claims below.

I claim:

1. A beverage container sleeve comprising:
a beverage container compartment having a bottom and a top;
a power bank compartment having a charging port and an aperture, the power bank compartment being attached to the bottom of the beverage container compartment; and
a power bank having a charging plug receptacle, the power bank configured for removable insertion into the power bank compartment through the aperture such that the charging plug receptacle is disposed in aligned communication with the charging port.

2. The beverage container sleeve of claim 1, the power bank compartment comprising a sidewall having a cover member disposed in proximity to the charging port.

3. The beverage container sleeve of claim 1, further comprising a divider disposed between the beverage container compartment and the power bank compartment.

4. The beverage container sleeve of claim 3, wherein the divider is a bottom panel in the beverage container compartment.

5. The beverage container sleeve of claim 3, wherein the divider is a top panel in the power bank compartment.

6. The beverage container sleeve of claim 2, further comprising a divider disposed between the beverage container compartment and the power bank compartment.

7. The beverage container sleeve of claim 6, wherein the divider is a bottom panel in the beverage container compartment.

8. The beverage container sleeve of claim 6, wherein the divider is a top panel in the power bank compartment.

9. The beverage container sleeve of claim 1, wherein the aperture has an elastic collar configured to retractably expand to accommodate insertion and removal of the power bank into and from the power bank compartment.

10. A beverage container sleeve comprising:
a beverage container compartment having a bottom and a top;
a power bank compartment having a charging port, the power bank compartment being attached to the bottom of the beverage container compartment;
a power bank having a charging plug receptacle, the power bank configured for removable insertion into the power bank compartment such that the charging plug receptacle is disposed in aligned communication with the charging port; and
a divider disposed between the beverage container compartment and the power bank compartment, the divider being a substantially circular panel having a circumferential edge with a fixed portion and a free portion, the fixed portion being attached to the inside of either the beverage container compartment or the power bank compartment such that the free portion of the circumferential edge enables the divider to be drawn into an open position to enable the removable insertion of the power bank into the power bank compartment.

11. The beverage container sleeve of claim 10, further comprising an annular shelf configured to support the free portion of the divider.

12. The beverage container sleeve of claim 10, wherein the divider is a bottom panel in the beverage container compartment.

13. The beverage container sleeve of claim 10, wherein the divider is a top panel in the power bank compartment.

14. The beverage container sleeve of claim 10, the power bank compartment comprising a sidewall having a cover member disposed in proximity to the charging port.

15. The beverage container sleeve of claim 11, the power bank compartment comprising a sidewall having a cover member disposed in proximity to the charging port.

16. The beverage container sleeve of claim 15, wherein the divider is a bottom panel in the beverage container compartment.

17. The beverage container sleeve of claim 15, wherein the divider is a bottom panel in the beverage container compartment.

18. A beverage container sleeve comprising:
a beverage container compartment having a bottom and a top;
a power bank compartment having a charging port, the power bank compartment being removably attached to the bottom of the beverage container compartment by a connection mechanism;
a power bank having a recharging port and a mobile device charging plug receptacle, the power bank disposed in the power bank compartment such that the mobile device charging plug receptacle is disposed in aligned communication with the charging port; and
a divider disposed between the beverage container compartment and the power bank compartment.

19. The beverage container sleeve of claim 18, wherein the connection mechanism between the power bank compartment and the beverage container compartment comprises a threaded connection.

20. The beverage container sleeve of claim 18, wherein the connection mechanism between the power bank compartment and the beverage container compartment comprises a clip assembly.
